(19) United States
(12) Patent Application Publication
(10) Pub. No.: US 2023/0398816 A1
(43) Pub. Date: Dec. 14, 2023

(54) TIRE TREAD MONITORING SENSOR, AND SYSTEMS AND METHODS FOR THE USE OF THE TIRE TREAD MONITORING SENSOR

(71) Applicant: BLUEDOT VENTURES, LLC, Rancho Santa Fe, CA (US)

(72) Inventors: Dave C. Ghilarducci, Escondido, CA (US); Steven J. Elliott, Encinitas, CA (US)

(21) Appl. No.: 18/205,141

(22) Filed: Jun. 2, 2023

Related U.S. Application Data
(60) Provisional application No. 63/352,059, filed on Jun. 14, 2022.

(51) Int. Cl. B60C 11/24; B29D 30/06

(52) U.S. Cl. CPC B60C 11/246; B60C 11/243; B29D 30/0681

(57) ABSTRACT

Tire tread monitoring systems and tire tread monitoring sensors are disclosed. In one embodiment, a tire tread monitoring sensor is disclosed that includes a sensor housing having communication circuitry disposed therein; a sensor flange that is disposed adjacent the sensor housing, the sensor flange being manufactured from a flexible or semi-flexible material; and a sensor post having one or more sensor leads, the one or more sensor leads being in signal communication with the communication circuitry. When the one or more sensor leads are worn down to a predetermined dimension, a continuity measurement indicates a change in state that is interpreted by the communication circuitry as a signal representative of the tire wear status of a tire as monitored by the tire tread monitoring sensor. Methods of installing, manufacturing and using the aforementioned systems and sensors are also disclosed.

### PRIORITY

This application claims the benefit of priority to U.S. Provisional Patent Application Ser. No. 63/352,059 filed Jun. 14, 2022 and entitled “Tire Tread Monitoring System and Methods”, the contents of which being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### Field of the Disclosure

The present disclosure relates generally to the field of tire tread monitoring systems and in one exemplary aspect, to a tire tread monitoring sensor and methods for manufacturing and using the same.

### Description of Related Art

Tires on motor vehicles are utilized as an interface between the motor vehicle upon which the tires are mounted and road or ground surfaces. Many tires also utilize treads on the outer surface of the tires that directly interact with the road or ground surfaces in order to effectively grip the road or ground surface in a variety of operating conditions. However, as these tires are used, the treads on these tires wear down resulting in a less effective gripping surface that can create potentially dangerous operating conditions for the motor vehicle. In the context of commercial trucking fleets, tire replacement costs are consistently named the top maintenance cost for their vehicles. As a result, operators and managers of commercial trucks must balance the safety risks associated with tires that are worn with the costs associated with tire replacement. Accordingly, operators and managers of commercial trucks are looking for ways to safely maximize the life of the tires used in their trucking fleets.

One monitoring metric for determining the longevity of a tire is to monitor the mileage that is put onto a given tire. Unfortunately monitoring the mileage placed on a tire is not necessarily an accurate means by which to determine the useful operating life for a tire. For example, tires that are exposed to non-paved surfaces tend to have a shorter operating life than tires that are used mainly on highways since these non-paved surfaces tend to increase the wear on the tire. More recently, tire tread laser measuring systems have been utilized to accurately measure tread depth and thus, the amount of wear experienced by the tire. However, these laser measuring systems are often times a limited resource due to their relatively high cost resulting in unnecessary travel for the operators of the vehicles being monitored as well as associated downtime for the vehicle's operation. Accordingly, improved tire tread monitoring systems are needed to more efficiently balance the tradeoff between maximizing tire life while minimizing the safety risks associated with worn tires.

### SUMMARY

The present disclosure satisfies the foregoing needs by providing, inter alia, tire tread monitoring systems, as well as methods of their manufacture and use that address the aforementioned deficiencies in the prior art.

In one aspect of the present disclosure, a tire tread monitoring sensor is disclosed. In one embodiment, a tire tread monitoring sensor is disclosed. The tire tread monitoring sensor includes a sensor housing having communication circuitry disposed therein; a sensor flange that is disposed adjacent the sensor housing, the sensor flange manufactured from a flexible or semi-flexible material; and a sensor post having one or more sensor leads, the one or more sensor leads being in signal communication with the communication circuitry. When the one or more sensor leads are worn down to a predetermined dimension, a continuity measurement indicates a change in state that is interpreted by the communication circuitry as a signal representative of tire wear status as monitored by the tire tread monitoring sensor.

In one variant, an underside of the sensor flange is coated with an adhesive, the adhesive being utilized to secure the tire tread monitoring sensor to a tire.

In another variant, the sensor flange includes a butyl overmold material.

In yet another variant, the communication circuitry includes an antenna, the antenna configured for wireless communication of data determined by the communication circuitry.

In yet another variant, the communication circuitry operates in accordance with a wireless communication protocol, the wireless communication protocol having radio frequency (RF) pulses that are transmitted using pulse position modulation (PPM).

In yet another variant, the communication circuitry is powered by a power source, the power source being positioned within the sensor housing.

In yet another variant, the sensor post further includes a sensor lead guard, the sensor lead guard being disposed between an exterior surface of the sensor post and the one or more sensor leads.

In yet another variant, the one or more sensor leads includes two sensor leads, the two sensor leads each having a respective length, the difference in the respective lengths corresponding to a wear dimension for a tire to be monitored by the tire tread monitoring sensor.

In yet another variant, the sensor post comprises a first sensor post and a second sensor post, wherein the first sensor post is configured to measure a first wear dimension for a tire to be monitored by the tire tread monitoring sensor and the second sensor post is configured to measure a second wear dimension for the tire to be monitored by the tire tread monitoring sensor, the first wear dimension differing from the second wear dimension.

In yet another variant, the sensor post includes a first set of one or more sensor leads and a second set of one or more sensor leads, wherein the first set of the one or more sensor leads is configured to measure a first wear dimension for a tire to be monitored by the tire tread monitoring sensor and the second set of the one or more sensor leads is configured to measure a second wear dimension for the tire to be monitored by the tire tread monitoring sensor, the first wear dimension differing from the second wear dimension.

In yet another variant, the communication circuitry is configured to transmit periodic heartbeat signals, the periodic heartbeat signals indicating operational status for the tire tread monitoring sensor.

In yet another variant, the change in state includes either a change in state from a logical high to a logical low, or a change in state from a logical low to a logical high.

In another aspect of the present disclosure, systems that utilize the aforementioned tire tread monitoring sensor are also disclosed. In one embodiment, the system includes a plurality of the aforementioned tire tread monitoring sensors and at least one receiver. Once a tire tread monitoring sensor determines that a tire tread has been worn down to a sufficient degree, a signal is transmitted from the tire tread monitoring sensor and received by the receiver. The receiver then transmits a signal indicative of the need to replace a tire as well as the location of the tire on the vehicle.

In one variant, the sensor flange is configured to be placed on an internal surface of a tire and the sensor post is configured to be placed in a body of the tire.

In another variant, the communication circuitry of the tire tread monitoring sensor operates in accordance with a wireless communication protocol that utilizes radio frequency (RF) pulses that are transmitted using pulse position modulation (PPM).

In yet another variant, the system includes a plurality of tire tread monitoring sensors and the receiver is configured to determine which one of the plurality of tire tread monitoring sensors has transmitted a given signal received by the receiver.

In yet another variant, two or more of the plurality of tire tread monitoring sensors are positioned within a given tire. The receiver is configured to receive signals transmitted by the two or more of the plurality of tire tread monitoring sensors and the receiver is further configured to communicate signals to an external computing system, the signals communicated to the external computing system being indicative of whether the given tire needs to be replaced.

In yet another variant, the tire tread monitoring sensor is positioned within a given tire and the receiver is configured to receive signals transmitted by the tire tread monitoring sensor. The receiver is further configured to communicate signals to an external computing system, the signals communicated to the external computing system being indicative of whether the given tire needs to be replaced.

In yet another aspect, methods of installing a tire tread monitoring sensor are disclosed. In one embodiment, the method includes obtaining a tire tread monitoring sensor having a sensor housing that includes communication circuitry disposed therein; a sensor flange that is disposed adjacent the sensor housing, the sensor flange comprised of a flexible or semi-flexible material; and a sensor post, the sensor post having one or more sensor leads, the one or more sensor leads being in signal communication with the communication circuitry. The method further includes inserting the sensor post of the tire tread monitoring sensor into an internal surface of a tire and seating an underside of the sensor flange on the internal surface of the tire such that the sensor housing is positioned within an interior void of the tire and the sensor post is inserted within a body of the tire.

In one variant, the method further includes using an adhesive disposed on the underside of the sensor flange to secure the tire tread monitoring sensor to the tire.

In yet another aspect of the present disclosure, methods of using the aforementioned tire tread monitoring system are disclosed.

In yet another aspect of the present disclosure, methods of manufacturing the aforementioned tire tread monitoring system are disclosed.

Other features and advantages of the present disclosure will immediately be recognized by persons of ordinary skill in the art with reference to the attached drawings and detailed description of exemplary implementations as given below.

### BRIEF DESCRIPTION OF THE DRAWINGS

FIG. 1A is a perspective view of an exemplary tire tread monitoring sensor, in accordance with the principles of the present disclosure.

FIG. 1B is a front plan view of the exemplary tire tread monitoring sensor illustrated in FIG. 1A, in accordance with the principles of the present disclosure.

FIG. 1C is a cross-sectional view of the exemplary tire tread monitoring sensor of FIG. 1A, in accordance with the principles of the present disclosure.

FIG. 2A is a perspective view of an exemplary tire tread monitoring system, in accordance with the principles of the present disclosure.

FIG. 2B is a detailed perspective view of the exemplary tire tread monitoring sensor installed in the tire of an automobile, in accordance with the principles of the present disclosure.

All Figures disclosed herein are © Copyright 2022-2023 BlueDot Ventures, LLC All rights reserved.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations, but other implementations are possible by way of interchange of, substitution of, or combination with some or all of the described or illustrated elements. Wherever convenient, the same reference numbers will be used throughout the drawings to refer to same or like parts.

Moreover, while embodiments described herein are primarily discussed in the context of tire tread monitoring, it will be recognized by those of ordinary skill that the present disclosure is not so limited. In fact, the principles of the present disclosure described herein may be readily applied to other types of wear monitoring systems. For example, one common type of wear monitoring system concerns the use of pipes or pipelines that transport toxic or highly abrasive materials. The principles of the tire tread monitoring system described herein may be readily adapted for use in the monitoring of wear for these pipes or pipelines, or in other applications where wear determination may benefit from the principles disclosed herein.

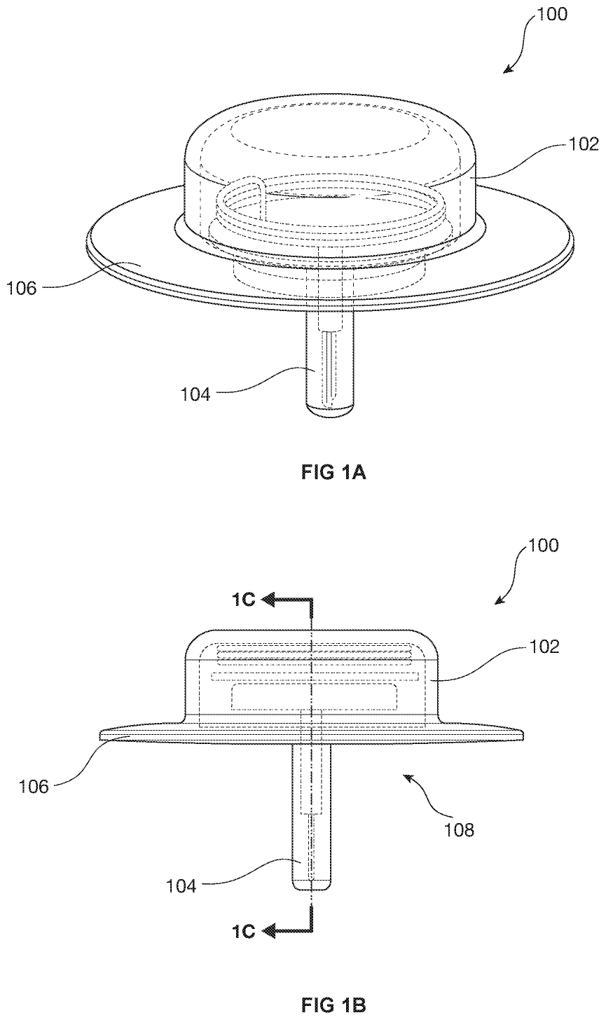

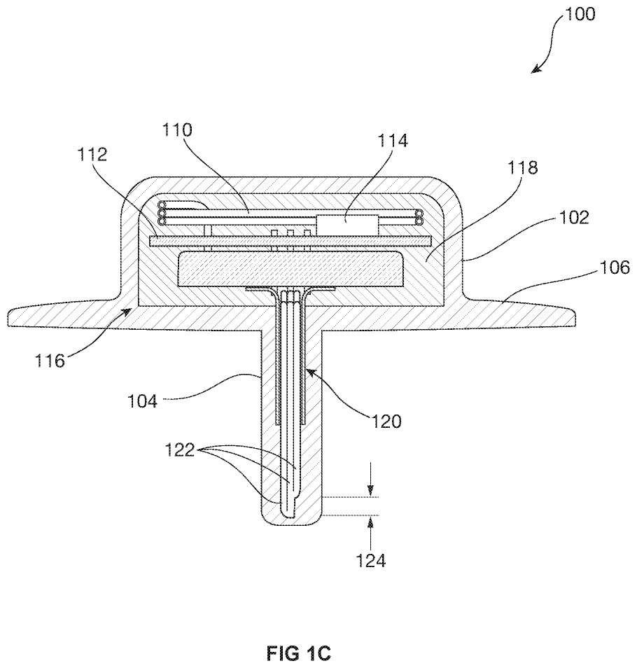

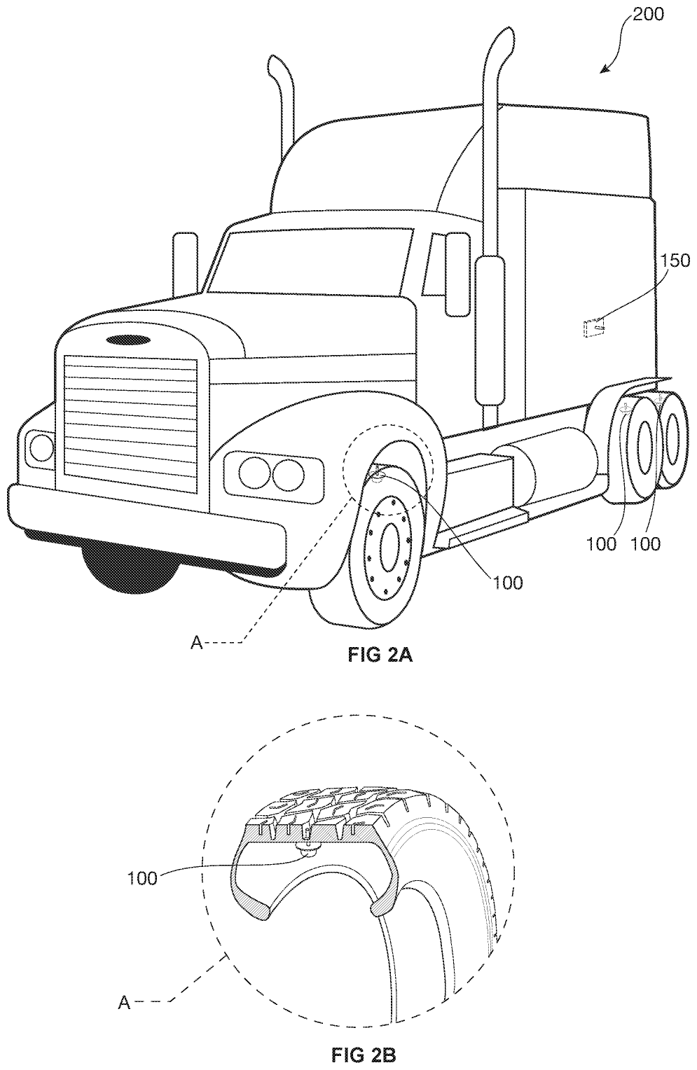

Referring now to FIGS. 1A-1C, an exemplary tire tread monitoring sensor 100 is shown and described in detail. As can be seen in FIGS. 1A-1B, the exemplary tire tread monitoring sensor 100 consists of three main external components, namely the sensor housing 102; the sensor post 104; and the sensor flange 106. The tire tread monitoring sensor 100 is mountable on the interior surface of a tire with the underside of the flange 108 being positioned on the interior surface of the tire (see also FIG. 2B). The sensor post 104 is inserted into the body of the tire, while the sensor housing 102 is positioned internal to the tire (i.e., in the internal void of the tire). Tire patches may be utilized in order to help seal the tire once the sensor post 104 has been inserted therein. The underside of the sensor flange 108 may be coated with, for example, an adhesive to help secure the tire tread monitoring sensor 100 to the internal surface of the tire. The sensor flange 104 (as well as the outer surface of the sensor housing 102 in some implementations) may be manufactured from a soft flexible material such as, for example, a butyl overmold to, inter alia, prevent the leakage of air through the cavity in which the sensor post 104 is inserted. In one exemplary implementation for use with semi-trucks, the sensor flange 106 may have a diameter of approximately 50 mm while the sensor housing 102 may have a diameter of approximately 30 mm. The diameter of the sensor post 104 may have a dimension of approximately 4.5 mm. The height of the tire tread monitoring sensor 100 from the underside of the sensor flange 108 to the top of the sensor housing 102 may have a dimension of approximately 13.4 mm. While exemplary dimensions for the tire tread monitoring sensor 100 are described herein, it would be readily apparent to one of ordinary skill given the contents of the present disclosure that these dimensions may be readily adapted for use in alternative applications and/or for use with other electronic components disposed within the sensor housing 102.

Referring now to FIG. 1C, a cross-sectional view of the tire tread monitoring sensor 100 taken along line 1C-1C in FIG. 1B is shown so that various internal components for the tire tread monitoring sensor 100 can be seen. The communication circuitry for the tire tread monitoring sensor 100 is disposed within the sensor housing 102. The communication circuitry includes a circuit substrate 112, one or more electronic components 114, and an antenna 110. The antenna 110 may consist of a coil antenna having a radiating length that corresponds to a quarter wavelength antenna. For example, for an antenna 110 that is intended to transmit at approximately 434 MHz, the operating length of the antenna 110 may be approximately 17 cm in length. While a coil antenna as illustrated is exemplary, it would be readily apparent to one of ordinary skill given the contents of the present disclosure that other types of antennas and other operating frequency bands (with varying bandwidths) may be readily implemented in order to operate in an intended frequency band.

The one or more electronic components 114 may take as input, signals received or otherwise derived from the sensor leads 122 disposed within the sensor post 104 and output signals to the antenna 110 that are indicative of tire tread wear of the tire upon which the tire tread monitoring sensor 100 is mounted. For example, the input received from the sensor leads 122 may be determined as a continuity measurement. In other words, the sensor leads 122 may act as a switch. In such an implementation, the sensor leads 122 may operate by holding the sensor leads 122 as a logical high (or logical low). Accordingly, depending on the current usage that is read by the one or more electronic components 114 (e.g., a microcontroller), the one or more electronic components 114 may determine that the tire treads have operating life left on them and do not need to be replaced (e.g., by determining that there is continuity or no continuity for the sensor leads 122), or the one or more electronic components 114 may determine that the tire treads have no operating life left on them and do need to be replaced (e.g., by determining that there is no continuity (or is continuity) for the sensor leads 122). In other words, the trigger for determination that the tires need to be replaced will be a state change from a connected to disconnected state (or vice versa). The one or more electronic components 114 may consist of one or more integrated circuits (e.g., one or more microcontrollers) that are configured to operate according to a communication protocol. For example, the one or more electronic components 114 may operate in accordance with a short-range communication protocol such as Micro.sp®. The antenna 110, circuit substrate 112, power source 116 and the one or more electronic components 114 may be encapsulated using an encapsulant 118 such as, for example, an epoxy potting compound.

As a brief aside, Micro.sp® technology utilizes relatively short-range radio frequency (RF) pulses that are transmitted using pulse position modulation (PPM) which provides for high RF peak power in order to ensure radio link reliability, while also utilizing a relatively small amount of power from the power source 116. The power source 116 may include, for example, a battery source for powering the underlying microcontroller and/or electronic components 114. Data transmission, using Micro.sp® technology, is based on a surface acoustic wave (SAW) stabilized RF circuit capable of generating RF PPM pulses that are modulated by the one or more electronic components 114 such as, for example, a microcontroller. These RF PPM pulses may be utilized to transmit the information generated by the tire tread monitoring sensor 100 as discussed subsequently herein.

The sensor post 104 may accommodate the sensor leads 122. A sensor lead guard 120 may also be incorporated into the sensor post 104 to ensure, inter alia, that the sensor leads 122 are maintained in their desired orientation (i.e., orthogonal to the mounting surface of the tire) as shown in FIG. 1C. The sensor guard 120 may help provide additional strength to the sensor leads 122 as the sensor post 104 is inserted into the tire. The sensor leads 122 may also include a wear dimension 124 when installed into the tire of the motor vehicle. This wear dimension 124 may be set so as to be equal to the desired amount of tire tread wear for the tires, before these tires should be replaced with a new set of tires. For example, in one exemplary implementation, the wear dimension 124 may be set to a dimension of 1.7 mm. As the treads of the tires get worn down, the portion of the sensor leads 122 protruding into the wear dimension 124 will also get worn down. Once the sensor leads 122 wears down to the point that the wear dimension approaches zero, the communication circuitry present within the sensor housing 102 will signal to a receiver (e.g., receiver 150, FIG. 2A) which in turn provides an indication that the tire being monitored by the tire tread monitoring sensor 100 should be replaced.

In some implementations, the tire tread monitoring sensor 100 may include two (or more) sensor posts 104 with accompanying sensor leads 122 and differing wear dimensions 124 for each of the two (or more) sensor posts 104. In such an implementation, the differing wear dimensions 124 for the tire tread monitoring sensor 100 with two (or more) sensor posts 104 enable an operator of the vehicle to determine various gradations of tire wear such as, for example, 25% of tire wear, 50% of tire wear, 75% of tire wear, and the like. As but another non-limiting example, the various gradations of tire wear may be determined based on, for example, the lead times associated with tire replacement. For example, one sensor post 104 may be indicative of 2/32 of an inch (1.59 mm) of tire tread and may serve as an indicator that new tires should be procured or otherwise ordered, while another sensor post 104 may be indicative of zero inches indicating that the tires should now be replaced. In some implementations, a single sensor post 104 may include two (or more) sets of sensor leads 122. Each of these two (or more) sets of sensor leads 122 may possess a different wear dimension 124, thereby enabling an operator of the vehicle to determine various gradations of tire wear. These and other tire tread wear indications would be readily apparent to one of ordinary skill given the contents of the present disclosure.

In some implementations, two (or more) tire tread monitoring sensors 100 may be mounted within a given tire to be measured. For example, the two (or more) tire tread monitoring sensors 100 may be mounted in a given tire that are spaced apart from one another within the tire (e.g., at 180° spacing, at 120° spacing, at 90° spacing, as well as at other predetermined uniform and/or non-uniform spacings). In such an implementation, a receiver may receive signals from these two (or more) tire tread monitoring sensors 100 and these signals may be interpreted by the receiver as a “vote.” Accordingly, the receiver may be configured such that a majority vote is required in order for the tire being monitored by the tire tread monitoring sensor 100 to be considered worn. In an instance in which one of the two (or more) tire tread monitoring sensors 100 is operational, while the other tire tread monitoring sensor(s) 100 is/are non-operational, the vote from the operational tire tread monitoring sensor 100 may be considered a majority vote. Periodic heartbeat signals received from the tire tread monitoring sensors 100 may be utilized for the determination of the operational versus non-operational status for the tire tread monitoring sensors 100.

Referring now to FIGS. 2A-2B, an exemplary tire tread monitoring system 200 is shown and described in detail. As shown, the tire tread monitoring system 200 is mounted on a semi-truck, although it would be appreciated that the tire tread monitoring system 200 could be placed on other vehicles such as, for example, the trailer being hauled by the semi-truck or other types of powered and non-powered vehicles. The tire tread monitoring system includes the tire tread monitoring sensors 100 that are disposed on, for example, each of the semi-trucks tires. One or more tire tread monitoring receivers 150 are disposed on or inside of the truck. Accordingly, when a given tire tread monitoring sensor 100 transmits a signal indicative of the fact that the treads on a given tire have worn below an acceptable level, the receiver 150 will receive the signal transmitted by the tire tread monitoring sensor 100. The receiver 150 may then transmit a signal to an external computing system associated with, for example, the operator of the semi-truck (and/or to the operator of the semi-truck fleet) that indicates not only that a tire on the semi-truck needs to be replaced but may also indicate which tire on the semi-truck needs to be replaced.

The determination of which tire of the multiple tires that needs to be replaced may be determined by an identification signal that uniquely identifies a given tire tread monitoring sensor 100. The determination of which tire of the multiple tires that needs to be replaced may also be determined through use of directional antennas and/or through other means of determining the spatial direction of the signals being transmitted by the tire tread monitoring sensor 100 in addition to, or alternatively from, the identification signal transmitted by the tire tread monitoring sensor 100. Accordingly, herein lies one salient advantage for the tire tread monitoring system 200 described herein. Namely for the ability of the receiver 150 of signals transmitted by the tire tread monitoring sensor 100 to be mounted onto the motor vehicle itself, or to be mounted at another convenient location that avoids the unnecessary travel by the operator of the motor vehicle as well as the associated downtime present utilizing known tire tread monitoring systems such as the aforementioned laser-based systems.

Referring now to FIG. 2B, the sensor post 104 of the tire tread monitoring sensor 100 is shown disposed between the treads on the outside surface of the tire. Such an implementation may be desirable in some situations dependent upon the tire tread geometry on the outside of the tire as well as the positioning of the tire tread monitoring sensor 100 in a place where wear of the tire may be expected to be maximized. However, it would be readily appreciated that in some implementations the sensor post 104 of the tire tread monitoring sensor 100 may be embedded within the tread of the tire itself. For example, it may be desirable to embed the tire tread monitoring sensor 100 within the tread of the tires as the additional tire material may serve to further strengthen and support the orthogonal orientation of the sensor post 104. Moreover, in some implementations, it may be desirable to place two or more tire tread monitoring sensors 100 within a given tire in order to provide additional granularity as to how that particular tire was wearing. For example, one tire tread monitoring sensor 100 may be inserted medial of the center line of the tire, while another tire tread monitoring sensor 100 may be inserted laterally of the center line of the tire. Such an implementation may be desirable in instances in which there may be uneven tire wear on either or both of the medial and lateral portions of the tire. These and other variants would be readily understood by one of ordinary skill given the contents of the present disclosure.

Where certain elements of these implementations can be partially or fully implemented using known components, only those portions of such known components that are necessary for an understanding of the present disclosure are described, and detailed descriptions of other portions of such known components are omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

It will be recognized that while certain aspects of the technology are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

What is claimed:

1. A tire tread monitoring sensor, comprising:
a sensor housing comprising communication circuitry disposed therein;
a sensor flange that is disposed adjacent the sensor housing, the sensor flange comprised of a flexible or semi-flexible material; and
a sensor post, the sensor post comprising one or more sensor leads, the one or more sensor leads being in signal communication with the communication circuitry;
wherein when the one or more sensor leads are worn down to a predetermined dimension, a continuity measurement indicates a change in state that is interpreted by the communication circuitry as a signal representative of tire wear status as monitored by the tire tread monitoring sensor.

2. The tire tread monitoring sensor of claim 1, where an underside of the sensor flange is coated with an adhesive, the adhesive being utilized to secure the tire tread monitoring sensor to a tire.

3. The tire tread monitoring sensor of claim 2, wherein the sensor flange comprises a butyl overmold material.

4. The tire tread monitoring sensor of claim 1, wherein the communication circuitry comprises an antenna, the antenna configured for wireless communication of data determined by the communication circuitry.

5. The tire tread monitoring sensor of claim 4, wherein the communication circuitry operates in accordance with a wireless communication protocol, the wireless communication protocol comprising radio frequency (RF) pulses that are transmitted using pulse position modulation (PPM).

6. The tire tread monitoring sensor of claim 5, wherein the communication circuitry is powered by a power source, the power source being positioned within the sensor housing.

7. The tire tread monitoring sensor of claim 1, wherein the sensor post further comprises a sensor lead guard, the sensor lead guard being disposed between an exterior surface of the sensor post and the one or more sensor leads.

8. The tire tread monitoring sensor of claim 1, wherein the one or more sensor leads comprises two sensor leads, the two sensor leads each having a respective length, the difference in the respective lengths corresponding to a wear dimension for a tire to be monitored by the tire tread monitoring sensor.

9. The tire tread monitoring sensor of claim 1, wherein the sensor post comprises a first sensor post and a second sensor post, wherein the first sensor post is configured to measure a first wear dimension for a tire to be monitored by the tire tread monitoring sensor and the second sensor post is configured to measure a second wear dimension for the tire to be monitored by the tire tread monitoring sensor, the first wear dimension differing from the second wear dimension.

10. The tire tread monitoring sensor of claim 1, wherein the sensor post comprises a first set of one or more sensor leads and a second set of one or more sensor leads, wherein the first set of the one or more sensor leads is configured to measure a first wear dimension for a tire to be monitored by the tire tread monitoring sensor and the second set of the one or more sensor leads is configured to measure a second wear dimension for the tire to be monitored by the tire tread monitoring sensor, the first wear dimension differing from the second wear dimension.

11. The tire tread monitoring sensor of claim 1, wherein the communication circuitry is configured to transmit periodic heartbeat signals, the periodic heartbeat signals indicating operational status for the tire tread monitoring sensor.

12. The tire tread monitoring sensor of claim 1, wherein the change in state comprises either a change in state from a logical high to a logical low, or a change in state from a logical low to a logical high.

13. A tire tread monitoring system, the system comprising:
a tire tread monitoring sensor, the tire tread monitoring sensor comprising:
a sensor housing comprising communication circuitry disposed therein;
a sensor flange that is disposed adjacent the sensor housing, the sensor flange comprised of a flexible or semi-flexible material; and
a sensor post, the sensor post comprising one or more sensor leads, the one or more sensor leads being in signal communication with the communication circuitry;
wherein when the one or more sensor leads are worn down to a predetermined dimension, a continuity measurement indicates a change in state that is interpreted by the communication circuitry as a signal representative of tire wear status as monitored by the tire tread monitoring sensor; and
a receiver that is configured to receive signals transmitted by the tire tread monitoring sensor.

14. The tire tread monitoring system of claim 13, wherein the sensor flange is configured to be placed on an internal surface of a tire and the sensor post is configured to be placed in a body of the tire.

15. The tire tread monitoring system of claim 14, wherein the communication circuitry of the tire tread monitoring sensor operates in accordance with a wireless communication protocol that utilizes radio frequency (RF) pulses that are transmitted using pulse position modulation (PPM).

16. The tire tread monitoring system of claim 13, further comprising a plurality of tire tread monitoring sensors and wherein the receiver is configured to determine which one of the plurality of tire tread monitoring sensors has transmitted a given signal received by the receiver.

17. The tire tread monitoring system of claim 16, wherein two or more of the plurality of tire tread monitoring sensors are positioned within a given tire; and
wherein the receiver is configured to receive signals transmitted by the two or more of the plurality of tire tread monitoring sensors and the receiver is further configured to communicate signals to an external computing system, the signals communicated to the external computing system being indicative of whether the given tire needs to be replaced.

18. The tire tread monitoring system of claim 13, wherein the tire tread monitoring sensor is positioned within a given tire; and
wherein the receiver is configured to receive signals transmitted by the tire tread monitoring sensor and the receiver is further configured to communicate signals to an external computing system, the signals communicated to the external computing system being indicative of whether the given tire needs to be replaced.

19. A method of installing a tire tread monitoring sensor, the method comprising:
obtaining the tire tread monitoring sensor, the tire tread monitoring sensor comprising:
a sensor housing comprising communication circuitry disposed therein;
a sensor flange that is disposed adjacent the sensor housing, the sensor flange comprised of a flexible or semi-flexible material; and
a sensor post, the sensor post comprising one or more sensor leads, the one or more sensor leads being in signal communication with the communication circuitry;
inserting the sensor post of the tire tread monitoring sensor into an internal surface of a tire; and
seating an underside of the sensor flange on the internal surface of the tire such that the sensor housing is positioned within an interior void of the tire and the sensor post is inserted within a body of the tire.

20. The method of claim 19, further comprising using an adhesive disposed on the underside of the sensor flange to secure the tire tread monitoring sensor to the tire.
